(19) United States
(12) Patent Application Publication
(10) Pub. No.: US 2026/0111950 A1
(43) Pub. Date: Apr. 23, 2026

(54) Ending a Vehicle Rental by Way of a Terminal Directly at the Vehicle

(71) Applicant: Bayerische Motoren Werke Aktiengesellschaft, Muenchen (DE)

(72) Inventor: Matthias FINK, Muenchen (DE)

(21) Appl. No.: 19/332,618

(22) Filed: Sep. 18, 2025

(30) Foreign Application Priority Data
Oct. 18, 2024 (DE) 10 2024 130 379.4

(51) Int. Cl. G06Q 30/0645

(52) U.S. Cl. CPC G06Q 30/0645

(57) ABSTRACT

A method for ending a rental of a vehicle rented by a renter from a rental agency, where a terminal is assigned to the renter and the terminal contains a digital key for the vehicle, which is managed by a producer backend. The ending of the rental is requested at the terminal. It is checked whether a communication connection currently exists between the terminal and the vehicle. If no, the method waits for the communication connection or the method is ended. If yes, the terminal requests the deletion of the key in the vehicle by a delete command via the communication connection. The key in the vehicle is deleted upon the request. After deletion, a message is sent to the producer backend, upon which the key is marked for termination in the producer backend and the termination is confirmed. The rental is ended when the producer backend confirms termination.

### CROSS REFERENCE TO RELATED APPLICATION

This application claims priority under 35 U.S. C. § 119 from German Patent Application No. DE 10 2024 130 379.4, filed Oct. 18, 2024, the entire disclosure of which is herein expressly incorporated by reference.

### BACKGROUND AND SUMMARY

The invention relates to ending a rental of a vehicle, wherein the vehicle is or was rented by a renter from a rental agency and wherein a terminal is assigned to the renter and the terminal contains a digital key for the vehicle, which key is managed by a vehicle or producer backend. The producer is the producer of the vehicle. The key is linked to the rental/rental agency and is used for the access to or the operation/use of the vehicle and is to become invalid when the rental is or will be ended.

A system and a method for operating a key fob for use in a car sharing vehicle access system is known from DE 10 2018 111 262 A1, comprising the following steps: authenticating the key fob for use with a specific vehicle; receiving an activation command for the key fob; obtaining an authorization in order to control at least some vehicle functions on the vehicle with the aid of the vehicle commands; as a reaction to obtaining the authorization, transmitting one or more vehicle commands from the key fob; receiving a user input request which sends one of the vehicle commands to the vehicle; sending the requested vehicle command to the vehicle; and then canceling the authorization so that the key fob is excluded from the further control of the vehicle functions.

The object of the present invention is to propose improvements with respect to ending a rental of a vehicle rented by a renter from a rental agency in conjunction with a digital vehicle key—as was mentioned above.

The object is achieved by the methods, systems and devices described herein. Preferred or advantageous embodiments may be understood from the following description and the appended FIGURES.

The method is used to end a rental of a vehicle. In this case, the vehicle was or is rented by a renter from a rental agency. The ending is to take place here by way of the renter, thus upon his initiative. The method is based on the fact that a terminal is assigned to the renter and the terminal contains a digital key for the vehicle. The renter can operate, use, drive, etc. the vehicle with the aid of the key. The key is managed hereby vehicle backend. The key is linked to the rental agency, is thus to become invalid upon ending the rental, so that the renter no longer has access to the vehicle by means of the key upon ending the rental.

In the method, the ending of the rental is requested at the terminal. This is carried out in particular by the renter or an operating procedure of the renter at the terminal which is to trigger the ending of the rental.

It is then checked whether a communication connection currently exists between the terminal and the vehicle. If this connection exists, the check has thus run successfully, the terminal requests the deletion of the key by means of a deletion command in the vehicle via the communication connection.

In contrast, if the communication connection does not exist, the check thus has not run successfully, the method waits for the communication connection or the method is ended. In other words, a deletion of the key in the vehicle will not or cannot be requested without communication connection terminal—vehicle.

Only after the deletion of the key has been requested by the terminal via the communication connection via deletion command (only in the “yes” case above), is the key actually deleted in the vehicle upon this request.

After this deletion of the key in the vehicle, a message about this, thus about the successful/ended deletion, is sent to the producer backend. In particular a cryptographic confirmation of the deletion procedure takes place here.

“After the deletion” means here: immediately after the deletion or simultaneously with the deletion. The chronological correlation between deletion and sending the message is thus in the range of at most a few seconds, in particular less than 10/5/3/1 seconds. The duration in particular solely includes the technically typical required/necessarily occurring processing times for program handling of the two procedures (runtimes, delay times, . . . ). In other words, the vehicle backend is thus informed via message about the fact that the key in the vehicle has been or is now deleted. The information with the aid of the message can take place directly (from the vehicle to the backend) or—if the vehicle is off-line—via an app (signed termination information, for example, rental agency application/rental application, see below).

Upon the message (arrival of the message in the vehicle backend), the key is at least marked for termination in the vehicle backend. “At least marked” means that the key is either directly terminated or its termination is intended (“marked”). In any case, the termination of the key is then confirmed in the producer backend. Such signed termination information is used by the backend as a foundation in order to set the key to “DELETED/MARKED DELETED”. Furthermore, this can be stored for evidentiary purposes in the backend (cf. point “persist termination”below).

The rental is first ended when the vehicle backend has confirmed the termination of the key (also including its marking), a corresponding termination has thus actually taken place or at least has been marked. “Marking for termination” means that the termination is already premarked in the vehicle backend and is therefore logged, so that it can actually take place at the closest possible point in time (for example, arrival of a corresponding message directly from the vehicle, see below).

The confirmation of the termination takes place from the vehicle backend at the rental agency or its location responsible for the rental, for example, at a rental agency backend or a rental agency application on the terminal.

Because the key is actually factually deleted via the communication connection at a specific point in time in the vehicle and the rental is only then ended, it is ensured that after ending the rental, an access to the vehicle with the aid of the key is actually precluded. This can also be useful with regard to legal aspects, for example, with respect to a transfer of risk.

In particular, the overall procedure is represented from a technical aspect as follows:
The device requests the deletion, whereupon the vehicle gives one-time information (“nonce”) at the device in order to verify the procedure later.
The device signs the one-time information (key is the digital vehicle key of the rental customer).
The vehicle verifies the signature of the one-time information, i.e. whether the signature was created by unknown key.
The vehicle in turn signs the signature of the device with further information (->key termination information).
The signed key termination information goes via various paths to the producer backend (vehicle if online, rental app, vehicle OEM proprietary section of the digital key mailbox).
The producer backend deletes the key and informs the rental backend to terminate the rental.

In one preferred embodiment, the vehicle sends the message (which informs about the deletion of the key in the vehicle) directly to the vehicle backend. This takes place as soon as possible, thus, for example, as soon as possible a communication direction (direct, thus not via the terminal/rental agency backend, see below) exists between vehicle and vehicle backend. The vehicle backend thereupon actually terminates the key (upon receipt of the message) and also confirms the termination (actual here) of the key. An actual key termination and a corresponding confirmation does take place upon the sending (direct: from the vehicle to the vehicle backend) of the messages. Viewed technically “the backend only keeps accounts”. A key has to be terminated (deleted) on the terminal side and vehicle side. If the termination is carried out by a third party (such as a backend), the relevant key is not hard deleted in the vehicle, but rather premarked for deletion (functional security/usage security). A key premarked for deletion would be finally deleted upon contact of another key. The hard deletion of a key has to be carried out by the user himself in order to ensure freedom from risk. If the vehicle is not reachable via mobile wireless, a delete command from the backend would also not be able to be executed (independently of the regulations on functional security).

The background is that unintentional or inadvertent deletion command by an “other” key can result in the extreme case and damage to life and limb, for example, if the vehicle is located far away and the person of the deleted key then can no longer get away from said location or important (vital) utensils/medications are in the vehicle and the vehicle is no longer accessible.

In one preferred embodiment (alternatively or additionally to the direct sending “vehicle to vehicle backend”), the vehicle sends the message (about the deletion of the key in the vehicle) initially to the terminal. The terminal sends the message (or corresponding message which likewise informs about the deletion of the key in the vehicle) to the vehicle backend. The core point at the location is that the vehicle cryptographically confirms (signature) the deletion of the key, which is forwarded from the terminal to the backend and in the case that the vehicle is off-line, permits a direct termination of the booking (cf. legal aspect with respect to transfer of risk above).

The vehicle backend thereupon likewise confirms (receipt of the message) the termination of the key (here in particular solely the marking for termination, even if the termination has actually not yet been carried out). In this embodiment, the messaging of the vehicle backend thus does not take place immediately/directly from the vehicle, but rather only indirectly via the detour via the terminal. The transmission of the message also takes place here in each case as soon as possible corresponding communication connections exist, thus as soon as possible.

In particular in combination with the embodiment above (immediately sending the message from the vehicle to the vehicle backend), two alternative paths arise for the transmission of the message. Depending on which communication connections (direct or indirect) exist earlier, the message thus arrives earlier at the vehicle backend via one of the two paths.

In a preferred variant of this embodiment, the vehicle backend checks (after receipt of the message from the terminal), whether it has already received the corresponding message (about the deletion of the key) directly from the vehicle or not. If this is not the case, the vehicle backend initially marks the key only as a key to be terminated, but does not yet actually terminate it. The key is only actually terminated when it later actually receives the message directly from the vehicle.

Compare in this regard the statements above on “backend only keeps accounts”; the key is actually terminated/deleted in the vehicle as soon as the vehicle deletes it on the basis of the termination request by the user (see, for example, the step “hard delete key” in the exemplary embodiment).

The backend could distinguish between
deleted in the vehicle and confirmed,
deleted in the vehicle (signed termination information received) and not yet confirmed by the vehicle.

However, the vehicle backend also confirms the key to be terminated (thus already after receipt of the message from the terminal) as “terminated”, so that as a result the rental can also already be ended when the key is initially only marked as to be terminated directly by the vehicle due to the absent message, but is not yet finally terminated. It is therefore ensured that the rental is ended as early as possible.

On the deletion confirmation it is also to be stated: The exemplary embodiment shows a sequence of the notifications from the rental agency backend (rental backend). In general, a service provider always receives an update if a key status changes (i.e. also in the case that the vehicle is online and the information from the vehicle arrives at the vehicle backend before the message from the terminal).

In one preferred embodiment, the terminal contains the rental application already mentioned above (“smart phone app”) of the rental agency. The rental application is configured to communicate with the rental agency backend also already mentioned or communicates if needed with it. The method explained in the present case here or substeps thereof are at least partially carried out at the rental application and/or by the rental agency backend with respect to the terminal.

The partial tasks/steps of the method which fall to the terminal can thus be carried out particularly well in the rental application intended for this purpose and/or particularly effectively in the rental agency backend. In particular, thus, for example:
the ending of the rental is requested at the rental application, and/or
the existence of the communication connection to the vehicle is checked by the rental application, and/or
messages which originate from the terminal or reach it are sent by the rental application or received thereby, and/or
the message about the deletion of the key is sent from the terminal to the vehicle backend, wherein the vehicle backend then sends the corresponding message or a corresponding message to the rental agency backend, and/or
the ending of the rental is implemented in the rental agency backend, etc.

In one preferred embodiment, as the communication connection between terminal and vehicle, a direct connection between these two instances is checked. Such a direct connection is in particular a BLE connection (Bluetooth low energy) between terminal and vehicle. Such direct connections are only available if the terminal (and therefore the renter) is located in range of the corresponding connection technology to the vehicle. This applies in particular if the renter in his last use/journey of the vehicle in the context of the rental, since he is necessarily located in this case at, in, or in the vicinity of the vehicle. An ending of the rental can therefore always take place “directly at the vehicle”, even if, for example, no communication connection of the vehicle to the vehicle backend exists, since the vehicle, for example, is parked in an underground garage or is located in a “dead zone”for mobile wireless connections, etc.

In one preferred embodiment, before the deletion of the key in the vehicle (thus after request to end the rental), it is checked whether the vehicle is in a target status. The key is only actually deleted in the vehicle when this is accurate. If this is not accurate, the method waits for the target status or the method is ended. In particular, for example, the renter/user is prompted to bring the vehicle into the target status. This takes place, for example, via a message at an HMI (human-machine interface) in the vehicle or at the terminal. In other words, the key is only deleted (and the rental is ended) when the vehicle is actually in the target status or has been brought therein, otherwise not. It is thus ensured that the vehicle is actually in the target status at the ending of the rental. Such a target status is, for example, that all windows and doors of the vehicle are closed, the electrical consumers thereof are switched off, the motor is switched off, the parking brake is activated. The target status can also relate to the vehicle being parked at a specific location (for example, checked via GPS coordinates), for example, on a parking area of the rental agency, etc. It can thus be ensured that the vehicle will be/is left behind as desired when the key is deactivated and the rental is ended.

The invention is based on the following findings, observations, or considerations and also includes the following preferred embodiments. These embodiments are sometimes also referred to here as “the invention”. The embodiments can also contain parts or combinations of the above-mentioned embodiments in this case or correspond thereto and/or can possibly also include embodiments which have not been previously mentioned.

Thanks to the invention, in particular a direct ending of a rental results (“Direct Termination of a Rental Vehicle Booking (hard delete)”).

The invention is based on the following observation from practice:

The digital car key solution (digital key for a vehicle/digital vehicle key) presently (Jan. 3, 2024) defined in the standard release 3 et seq. of the Car Connectivity Consortium (CCC) standardizes an access system to a vehicle consisting of
intelligent devices (terminal, for example, smart phone) and software (for example, app of the key), which
bear a digital key, which is embedded in a secure memory (“secure element/storage”) on the intelligent device
offer interfaces from the secure memory to the smart phone operating system and
offer interfaces from the smart phone operating system to other applications which run on the smart phone (for example, an app of a vehicle producer)
a vehicle, which enables the bearers of a digital key to operate specific vehicle functions,
backend systems which connect intelligent devices and vehicles to one another and the joint usage and management of digital keys and the provision of additional services.

Digital keys can be forwarded from one intelligent device to another (private application from user to user), from a server to a user, from a user to a server (service activation), or from a server to a server. Digital keys can also be deleted from a user or a server. This can be one's own key or an authorized key which can be managed by the user (the digital key of the user). Various rules apply upon the deletion of a digital key:

The deletion of one's own key on the device result in immediate ending (immediate termination).

The deletion of an arbitrary key in the vehicle requires an authorization unit, which has rights for managing the target key (authorized digital key or key fob). The deletion result in immediate ending of the target key (immediate termination).

The deletion of another key either on the device of the user or from a server results in a soft deletion of the key (self-deletion). The target key is not immediately ended (terminated, with respect to functional security/usage security)), but rather only marked for deletion. The actual deletion procedure is carried out when the vehicle is in a secure status, i.e. the vehicle is in contact with another key.

The invention is based on the following basic concept:

Stated briefly:
The renter and the booking/rental while he is still in contact with the vehicle and confirms the ending (termination) of the key.
The vehicle will directly terminate the key and confirm the termination.

In more detail:

When a rental customer reaches the destination, leaves the vehicle, and triggers the ending of the booking in the app of his terminal, the app checks whether a BLE vehicle connection still exists, and notifies the user that the vehicle key is deleted.

As soon the customer confirms the ending of the booking, the app sends a command to the vehicle to delete (terminate) the key. The termination of the key is signed by the vehicle and transmitted to the OEM backend (producer backend) of the vehicle and optionally returned to the rental agency app to be forwarded to the rental agency backend, which can forward the termination information to the vehicle OEM backend. After the ending, a key can no longer be used, neither to access the vehicle, nor to drive it, nor to fulfill another task.

One core aspect is furthermore that the vehicle confirms (signs) the deletion procedure and this information is sent from the vehicle to the backend (vehicle has to be online) and parallel through the app (this is important if the vehicle is off-line), to which the termination of the booking (transfer of risk) can be linked, viewed legally.

Further features, effects, and advantages of the invention result from the following description of a preferred exemplary embodiment of the invention and the appended FIGURES.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a flow chart for a method for ending a rental of a vehicle by a renter.

### DETAILED DESCRIPTION OF THE DRAWINGS

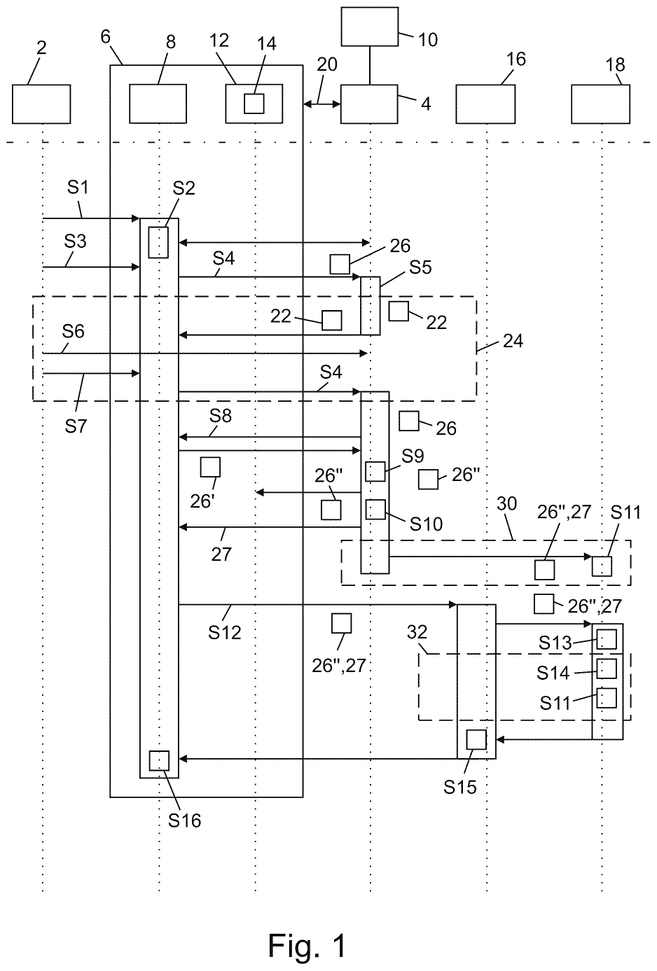

FIG. 1 shows a flow chart for a method for directly ending a rental of a vehicle 4 (direct termination of a rental vehicle booking).

The following participants participate in the method: a renter 2 of the vehicle 4, the vehicle 4 itself, and a terminal 6 (“device”), which is assigned to the renter 2, in the present case his smart phone. The terminal 6 contains a rental application 8 (“rental app”) here of a vehicle rental agency 10 of the vehicle 4 and a security element 12 (secure element), in which a digital key 14 is stored. The digital key 14 enables the renter 2 to use the vehicle 4, wherein this usage is to be limited to the rental time period in which the renter 2 has actually rented the vehicle 4.

Furthermore, a rental agency backend 16 participates in the method, which is configured for communication with the rental application 8. Finally, a producer backend 18 (also “vehicle backend”) of the producer of the vehicle 4 participates in the method.

The method describes the direct termination of a key 14 (direct termination of a rental key).

The condition for the method is that the renter 2 has ended his journey/use of the vehicle 4 and is located in the surrounding/vicinity of the vehicle 4 and now wishes to end the rental/booking of the rental. “Vicinity of the vehicle” means that a direct communication 20 exists between the terminal 6 and the vehicle 4.

Initially, in a step S1, the renter 2 requests the ending of the rental/booking of the vehicle 4 at the terminal 6 or the rental application 8. In a step S2, the communication connection 20 or its current existence between the terminal 6 or rental application 8 and vehicle 4 is checked. In addition, in step S2, request messages are sent to the renter 2 “Please check whether you have removed all personal objects from the vehicle 4.” and “The vehicle key 14 will be deleted.”.

The output of the messages takes place, for example, at the terminal 6 or the rental application 8.

In a step S3, the renter 2 thereupon confirms the wish to end the rental.

In a step S4, the rental application 8 sends a request to the vehicle 4 containing a delete command 26 in order to request termination one-time information (“key termination nonce”).

In a step S5, the status of the vehicle 4 is checked, namely whether it is in a target status 22. In the example, this states whether all windows are closed and all doors are closed and locked.

A frame 24 in FIG. 1 indicates that the target status 22 currently is not yet present. The vehicle 4 therefore reports to the rental application 8 that the vehicle is not in the target status 22. A pop-up is thereupon displayed to the renter 2 on the rental application 8 of the content that the vehicle is not in the target status 22.

Therefore, in a step S6, the renter 2 brings the vehicle 4 into the target status 22, thus closes the doors and windows unlocked the doors. He subsequently once again confirms in a step S7 the ending of the rental.

Step S4 is thereupon repeated once again. Since the target status 22 is now reached, the vehicle 4 now outputs the delete command 26 and returns it to the rental application 8 in a step S8. This application signs the delete command 26 and returns the signed delete command 26′ in the form of one-time information (signed termination nonce) back to the vehicle 4. The signature key here is the digital vehicle key (digital key) of the customer which is used for the rental for regular vehicle interaction (opening, starting, . . . ).

In a step S9, the vehicle 4 verifies the signature and once again undersigns (signature key on vehicle side is the vehicle-side digital key) the signed delete command 26. The key termination information is generated and signed by the vehicle 4 in order to also be able to forward further information in addition to the one-time information signed by the device (terminal 6).

The signing of the “key termination nonce”using the vehicle key then takes place.

In other words, the signed “key termination information” is propagated 18 at the rental application 8 and the producer backend, not only the signed one-time information.

Subsequently, the vehicle 4 writes the undersigned signed delete command 26″ (key termination information) at the terminal 6 or the security element 12, thus a digital key mailbox (vehicle OEM proprietary section/digital key mailbox). In other words, the proprietary section is brought into a termination confirmation (termination attestation) and also provided to the vehicle backend 18 when the digital key is deleted in the terminal 6 (can be available as an alternative way).

In a step S10, the actual deletion of the key 14 in the vehicle 4 (hard delete) then takes place. The signed undersigned delete command 26″ is thereupon returned as a message 27 about the completed deletion to the rental application 8.

A frame 30 illustrates a first alternative, that the vehicle 4 is online, i.e. a direct communication connection exists between vehicle 4 and vehicle backend 18. In the context of a message 27, the undersigned signed delete command 26″ is transmitted here to the vehicle backend 18, which, in a step S11, actually carries out the termination.

For the case that this is legally required, evidence is also provided that the direct termination of the key 14 was initiated by the renter 2. A propagation of the key status update takes place from the vehicle backend (producer backend 18) to the rental/rental agency backend 16 (see also above).

In a step S12, a request additionally takes place from the rental application 8 at the rental agency backend 16 to end the rental. The undersigned signed delete command 26″ is transmitted as a parameter.

The rental agency backend 16 thereupon requests the deletion of the key 14 at the vehicle backend 18, and likewise transmits the undersigned signed delete command 26″ as a parameter.

In a step S13, the vehicle backend 18 checks the key status.

In detail (not shown), the “signed key termination information” with the “key status changed information (deleted)” is sent in this case as the message from the vehicle 4 to the vehicle backend 18. The verification of the signature takes place there. For the case that it is required legally or in another way, the “signed key termination information” can be stored in the backend. A key status update to “deleted” then takes place. An event messaging to the rental agency backend 16 that the key was terminated then takes place. A corresponding update of the booking takes place there. A message then takes place from the rental agency backend 16 to the rental application 8 with respect to the key termination, which is indicated there.

The frame 32 shows the second alternative to the above, that the key status is still “not deleted”, since the vehicle 4 is located off-line, thus a communication connection has not existed up to this point between vehicle 4 and vehicle backend 18 (frame 30 is not yet fulfilled or could not be executed). In this case, the vehicle/producer backend 18 only saved the signed key termination information if the key 14 is already deleted.

In this alternative, in a step S14, the signature in the signed undersigned delete command 26″ is checked and the key 14 is marked here as “to be terminated (deleted)”. Step S11 is then likewise carried out as above in frame 30.

In detail (not shown) in this case—as above—if necessary the “signed key termination information” is stored in the vehicle/producer backend 18. An update then takes place in that the key is marked as deleted (“key: as deleted”): The key 14 can be marked as deleted and can be fully updated to “deleted” here as soon as the vehicle 4 directly confirms the deletion; In any case, the key 14 is no longer usable, since the “signed termination information” confirms its deletion in the vehicle 4.

An event messaging to the rental agency backend 16 then takes place: “key terminated”. An update takes place there that the booking is considered ended (“booking: terminated”). A message then takes place from the rental agency backend 16 to the rental application 8: “booking terminated”, which is indicated there.

Subsequently, in a step S15, a message about the key termination is sent from the vehicle backend 18 to the rental agency backend 16 and the booking/rental is updated there as ended.

Finally, in a step S16, the transmission of the result that the rental is ended takes place from the rental agency backend 16 to the rental application 8, which thereupon indicates the ending of the rental.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

2 renter
4 vehicle
6 terminal
8 rental application
10 vehicle rental agency
12 security element
14 key
16 rental agency backend
18 producer backend
20 communication connection (terminal-vehicle)
22 target status
24 frame
26 delete command
26′delete command signed
26″ delete command signed undersigned
27 message
30 frame
32 frame
S1-16 step

What is claimed is:

1. A method for ending a rental of a vehicle rented by a renter from a rental agency, wherein a terminal is assigned to the renter and the terminal contains a digital key for the vehicle, which is managed by a producer backend, the method comprising:
receiving a request for the ending of the rental at the terminal;
checking whether a communication connection currently exists between the terminal and the vehicle;
in response to the checking:
waiting for the communication connection, or ending the method, when the communication connection does not currently exist, and
when the communication connection does currently exist, requesting by the terminal the deletion of the key in the vehicle by means of a delete command via the communication connection;
deleting the key in the vehicle upon the request;
after deleting the key, sending a message about the deletion to the producer backend;
upon the message, marking the key for termination in the producer backend;
confirming the termination of the key;
ending the rental when the producer backend has confirmed the termination of the key.

2. The method according to claim 1,
wherein the vehicle sends the message directly to the producer backend,
wherein the producer backend terminates the key, and
wherein the producer backend confirms the termination of the key.

3. The method according to claim 1,
wherein the vehicle sends the message to the terminal,
wherein the terminal sends the message to the producer backend, and
wherein the producer backend confirms the termination of the key.

4. The method according to claim 3,
wherein the producer backend checks whether it has already received the message directly from the vehicle, and
wherein when the producer backend has not already received the message:
the producer backend initially marks the key as a key to be terminated until it receives the message directly from the vehicle and finally terminates the key, and
already confirms the key to be terminated as terminated.

5. The method according to claim 1,
wherein the terminal contains a rental application of the rental agency communicating with a rental agency backend, and
wherein the method with respect to the terminal is at least partially carried out at the rental application and/or at the rental agency backend.

6. The method according to claim 1, wherein a direct connection between terminal and vehicle is checked as the communication connection.

7. The method according to claim 1,
wherein, before the deletion of the key in the vehicle, it is checked whether the vehicle is in a target status, and
wherein, when the vehicle is in a target status, the key is deleted, and when the vehicle is not in the target status, the method returns to the check or the method is ended.
